(19) United States
(12) Patent Application Publication
(10) Pub. No.: US 2010/0231825 A1
(43) Pub. Date: Sep. 16, 2010

(54) ILLUMINATION APPARATUS, DISPLAY APPARATUS, AND ELECTRONIC DEVICE INCLUDING A DISPLAY APPARATUS

(75) Inventors: Norio KOMA, Gifu (JP); Kenji TANASE, Gifu (JP); Yasushi KARASAWA, Shiojiri (JP); Tadayoshi IKEHARA, Suwa (JP)

Correspondence Address: HARNESS, DICKEY & PIERCE, P.L.C., P.O. BOX 828, BLOOMFIELD HILLS, MI, 48303, US

(73) Assignee: SEIKO EPSON CORPORATION, Tokyo (JP)

(21) Appl. No.: 12/719,276

(22) Filed: Mar. 8, 2010

(30) Foreign Application Priority Data
Mar. 12, 2009 (JP) 2009-059059

(51) Int. Cl. G02F 1/13357; F21K 2/00

(52) U.S. Cl. 349/63; 362/240

(57) ABSTRACT

An illumination apparatus includes: a substrate; reflective layers formed upon the substrate; and light-emitting layers formed upon respective reflective layers and disposed so as to overlap the respective reflective layers when viewed from above. The reflective layers are formed in a convex shape protruding toward the respective light-emitting layers, and when reflecting light irradiated from the light-emitting layers, diffuse and reflect the light.

### BACKGROUND

1. Technical Field

The present invention relates to an illumination apparatus, a display apparatus, and an electronic device including a display apparatus, and particularly relates to an illumination apparatus, a display apparatus, and an electronic device provided with a light-emitting layer.

2. Related Art

A display apparatus provided with a light-emitting layer has been disclosed in the past (for example, see JP-A-2006-350303). The stated JP-A-2006-350303 discloses a display apparatus that includes an illumination unit in which multiple organic electroluminescence elements (organic EL elements) containing light-emitting layers are provided, and a reflective liquid crystal display unit that uses the illumination unit as its light source. With the display apparatus disclosed in JP-A-2006-350303, the illumination unit is configured as a front light, and is affixed to the reflective liquid crystal display unit. The illumination unit is configured as a top emission-type unit, whereby light from organic EL elements disposed upon one flat substrate is emitted toward the opposite side of the one substrate, and passes through another substrate provided opposing the organic EL elements, thereby being irradiated toward the reflective liquid crystal display unit. The light irradiated from the illumination unit is then reflected in the reflective liquid crystal display unit toward the illumination unit, passes through the illumination unit, and is thus emitted toward an observer.

With the display apparatus disclosed in JPA-2006-350303, the organic EL elements of the illumination unit used as a front light are provided between the reflective liquid crystal display unit and the observer, and therefore the reflected light from the reflective liquid crystal display unit is blocked by the organic EL elements, resulting in an issue whereby the luminance of the light emitted toward the observer decreases. Accordingly, a method whereby the interval at which the organic EL elements are disposed is increased in order to reduce the amount of reflected light that is blocked can be considered as a countermeasure for this issue. However, in such a case, there is a problem in that unevenness arises in the light irradiated from the organic EL elements on the reflective liquid crystal display unit as the interval between organic EL elements is increased.

### SUMMARY

An advantage of some aspects of the invention is to provide an illumination apparatus, a display apparatus, and an electronic device capable of suppressing a drop in luminance without causing unevenness to occur in the light emitted toward an observer.

An illumination apparatus according to a first aspect of the invention includes light-emitting layers formed upon the surface of a substrate and reflective layers disposed so as to overlap the light-emitting layers when viewed from above and reflecting light irradiated from the light-emitting layers, in which the reflective layers are formed in a convex shaped protruding toward respective light-emitting layers.

According to the illumination apparatus according to the aforementioned first aspect of the invention, forming the reflective layers in a convex shape protruding toward the light-emitting layers as described above makes it possible, when light from the light-emitting layers is reflected by the reflective layers, to irradiate the reflected light across a more widely dispersed range than in the case where the reflective layers are formed in a flat shape. Accordingly, because the light from the light-emitting layers can be dispersed by the reflective layers and irradiated, the occurrence of unevenness in the overall light emitted from the illumination apparatus can be suppressed, even if the numerical aperture is increased by increasing the interval at which the light-emitting layers and reflective layers are disposed. As a result, even in the case where, for example, a reflective liquid crystal display unit is disposed on the light-emission side of the illumination apparatus, it is possible to irradiate the reflective liquid crystal display unit with light that has no unevenness. Furthermore, even when the illumination apparatus is irradiated with reflected light from the reflective liquid crystal display unit, the interval at which the light-emitting layers are disposed can be increased (the numerical aperture can be increased) without causing the occurrence of unevenness in the light, which makes it possible to suppress the reflected light from the reflective liquid crystal display unit being blocked by the light-emitting layers. Accordingly, a drop in the luminance of the light irradiated toward an observer can be suppressed by that amount.

It is preferable, in the illumination apparatus according to the aforementioned first aspect of the invention, for the light-emitting layers to be formed in areas overlapping respective reflective layers when viewed from above, and to be formed in a convex shaped protruding in the direction in which the reflective layers protrude. According to this configuration, the light-emitting layers are formed in a convex shape along with the reflective layers, and thus in addition to the reflected light reflected by the reflective layers, the light emitted directly from the light-emitting layers toward the light-emission side can be dispersed and irradiated.

It is preferable for the illumination apparatus according to the aforementioned first aspect of the invention to further include convex-shaped portions, protruding in the direction from the substrate toward the reflective layers, provided in the surface of the substrate on the side thereof on which the reflective layers are disposed, and for the configuration to be such that the reflective layers are provided in a convex shape between respective light-emitting layers and convex-shaped portions in accordance with the shape of the convex-shaped portions, and so that of the light irradiated from the light-emitting layers, the light moving toward the substrate is reflected by the reflective layers in the direction opposite to the substrate and is emitted. According to this configuration, a top-emission type illumination apparatus that irradiates light from the light-emitting layers in the direction opposite to the substrate can be configured, and by forming the reflective layer so as to cover respective convex-shaped portions, it is possible to easily form the reflective layers in a convex shape in accordance with the shape of the convex-shaped portions.

In this case, it is preferable for the illumination apparatus to further include a first resin layer provided between the substrate and the reflective layers, and for the convex-shaped portions to be formed in the surface of the first resin layer on the side thereof on which the reflective layers are disposed, and to be formed as part of the first resin layer, and for the reflective layers to be formed so as to cover respective convex-shaped portions of the first resin layer. According to this configuration, forming the reflective layers so as to cover respective convex-shaped portions of the first resin layer provided between the substrate and the reflective layers makes it possible to easily form the reflective layers in a convex shape.

It is preferable, in the aforementioned configuration in which the convex-shaped portions are formed, for the convex-shaped portions to be formed in the surface of the substrate on the side thereof on which the reflective layers are disposed, and to be formed as part of the substrate, and for the reflective layers to be formed so as to cover respective convex-shaped portions of the substrate. According to this configuration, forming the convex-shaped portions as part of the substrate makes it possible to simplify the structure as compared to a case where the convex-shaped portions are disposed independently. Moreover, forming the reflective layers so as to cover respective convex-shaped portions formed in the substrate makes it possible to easily form the reflective layers in the convex shape.

It is preferable, in the aforementioned configuration in which the convex-shaped portions are provided, for the convex-shaped portions to be formed in a circular shape when viewed from above. According to this configuration, in the case where light is dispersed by the convex-shaped portions, it is possible to disperse the light uniformly in all directions when viewed from above.

It is preferable, in the illumination apparatus according to the aforementioned first aspect of the invention, for the substrate to include a light-transmissive substrate, and for the apparatus to further include concave-shaped portions formed upon the surface of the light-transmissive substrate on the side thereof on which the light-emitting layers are disposed; it is preferable for the configuration to be such that the reflective layers are provided on the light-transmissive substrate over respective light-emitting layers, and such that of the light irradiated from the light-emitting layers, the light moving in the direction opposite to the light-transmissive substrate is emitted by the reflective layers toward the light-transmissive substrate, and it is preferable for the reflective layers to be formed in a convex shape, protruding in the direction toward the light-transmissive substrate, in accordance with the shape of the concave-shaped portions. According to this configuration, a bottom emission-type illumination apparatus, in which light from the light-emitting layers is reflected by the reflective layers and irradiated toward the light-transmissive substrate, is configured. Because the reflective layers are formed in a convex shape protruding toward the light-transmissive substrate due to the concave-shaped portions of the light-transmissive substrate, in the bottom emission-type illumination apparatus, the light from the light-emitting layers can be emitted toward the light-transmissive substrate while being dispersed.

In this case, it is preferable for the apparatus to further include a second resin layer provided between the light-transmissive substrate and the light-emitting layers, and for the convex-shaped portions to be formed in the surface of the second resin layer on the side thereof on which the light-emitting layers are disposed, and to be formed as part of the second resin layer. According to this configuration, because the reflective layers are formed so as to cover the second resin layer in which the concave-shaped portions are provided as part thereof, the convex-shaped reflective layers can easily be formed in correspondence with the concave-shaped portions.

It is preferable, in the illumination apparatus according to the aforementioned first aspect of the invention, for the light-emitting layers to be configured of organic layers, for the apparatus to further include anode layers and cathode layers that apply a voltage for causing the organic layers to emit light, for organic electroluminescence elements to be configured from respective organic layers, anode layers, and cathode layers, and for the organic layers of each organic electroluminescence element to be formed in a convex shape protruding in the direction in which the convex shape of the reflective layers protrudes. According to this configuration, even in the case where the light source is configured of organic electroluminescence elements, light from the organic electroluminescence elements can be dispersed by the convex-shaped reflective layers, and the light irradiated from the convex-shaped organic layers toward the light-emission side can be dispersed as well.

A display apparatus according to a second aspect of the invention includes an illumination unit having light-emitting layers formed upon the surface of a substrate and reflective layers disposed so as to overlap the light-emitting layers when viewed from above and reflecting light irradiated from the light-emitting layers, the reflective layers being formed in a convex shaped protruding toward respective light-emitting layers; and a display unit that performs a display by reflecting light from the light-emitting layers of the illumination unit.

According to the display apparatus according to the aforementioned second aspect of the invention, forming the reflective layers of the illumination unit in a convex shape protruding toward the light-emitting layers as described above makes it possible, when light from the light-emitting layers is reflected by the reflective layers, to irradiate the reflected light across a more widely dispersed range than in the case where the reflective layers are formed in a flat shape. Accordingly, because the light from the light-emitting layers can be dispersed by the reflective layers and irradiated, the occurrence of unevenness in the overall light emitted from the illumination unit can be suppressed, even if the numerical aperture is increased by increasing the interval at which the light-emitting layers and reflective layers are disposed. As a result, a reflective liquid crystal display unit can be irradiated with light that has no unevenness by the illumination unit. Furthermore, even when the illumination apparatus is irradiated with reflected light from the reflective liquid crystal display unit, the interval at which the light-emitting layers are disposed can be increased (the numerical aperture can be increased) without causing the occurrence of unevenness in the light, which makes it possible to suppress the reflected light from the reflective liquid crystal display unit being blocked by the light-emitting layers. Accordingly, a drop in the luminance of the light irradiated toward an observer can be suppressed by that amount.

In this case, it is preferable for the display unit to be configured as a reflective liquid crystal display unit, for the light-emitting layers of the illumination unit to be configured as organic layers, for the illumination unit to further include anode layers and cathode layers that apply a voltage for causing the organic layers to emit light, for organic electroluminescence elements to be configured from respective organic layers, anode layers, and cathode layers, and for the light from the light-emitting layers of the illumination unit to be irradiated onto the reflective liquid crystal display unit in a state in which the light is diffused by the convex-shaped reflective layers. According to this configuration, even in the case where the light source of the illumination unit is configured of organic electroluminescence elements and the display unit is configured of a reflective liquid crystal display unit, because the light emitted from the organic electroluminescence elements is dispersed by the reflective layers formed in a convex shape, the occurrence of unevenness in the light irradiated onto the reflective liquid crystal display unit can be easily suppressed. Furthermore, because the interval at which the organic electroluminescence elements are disposed can be increased while suppressing the occurrence of unevenness in the light, part of the reflected light from the reflective liquid crystal display unit being blocked by the electroluminescence elements can be suppressed as well.

An electronic device according to a third aspect of the invention includes a display apparatus having the configuration described above. According to this configuration, it is possible to realize an electronic device that includes a display apparatus capable of suppressing a decrease in luminance without causing the occurrence of unevenness in light irradiated toward an observer.

### BRIEF DESCRIPTION OF THE DRAWINGS

The invention will be described with reference to the accompanying drawings, wherein like numbers reference like elements.

FIG. 1 is a cross-section of a display apparatus provided with an illumination apparatus according to a first embodiment of the invention.

FIG. 2 is a plan view of the illumination apparatus according to the first embodiment of the invention.

FIG. 3 is an enlarged plan view illustrating the configuration of a light source portion of the illumination apparatus according to the first embodiment of the invention.

FIG. 4 is a cross-section illustrating the light source portion of the illumination apparatus according to the first embodiment of the invention (a cross-section viewed along the IV-IV line shown in FIG. 3).

FIG. 5 is a cross-section illustrating the light source portion of the illumination apparatus according to the first embodiment of the invention (a cross-section viewed along the V-V line shown in FIG. 3).

FIG. 6 is a cross-section illustrating a display apparatus provided with an illumination apparatus according to the first embodiment of the invention.

FIG. 7 is a cross-section illustrating a light source portion of an illumination apparatus according to a second embodiment of the invention.

FIG. 8 is a cross-section illustrating a light source portion of an illumination apparatus according to a third embodiment of the invention.

FIG. 9 is a perspective view illustrating a first example of an electronic device provided with a display apparatus that includes the illumination apparatus according to the first through third embodiments of the invention.

FIG. 10 is a perspective view illustrating a second example of an electronic device provided with a display apparatus that includes the illumination apparatus according to the first through third embodiments of the invention.

FIG. 11 is a perspective view illustrating a third example of an electronic device provided with a display apparatus that includes the illumination apparatus according to the first through third embodiments of the invention.

### DESCRIPTION OF EXEMPLARY EMBODIMENTS

Hereinafter, embodiments of the invention will be described based on the drawings.

### First Embodiment

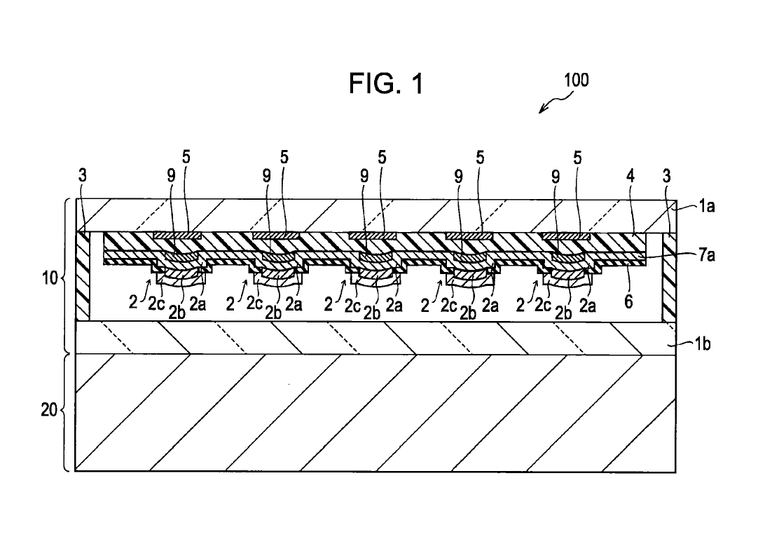

Hereinafter, the configuration of a display apparatus 100 according to a first embodiment of the invention will be described with reference to FIGS. 1 through 5.

The display apparatus 100 according to the first embodiment of the invention includes, as shown in FIG. 1, a front light-type illumination unit 10 and a reflective liquid crystal display unit 20. Note that the illumination unit 10 and the reflective liquid crystal display unit 20 are examples of an “illumination apparatus” and a “display unit”, respectively, according to the invention.

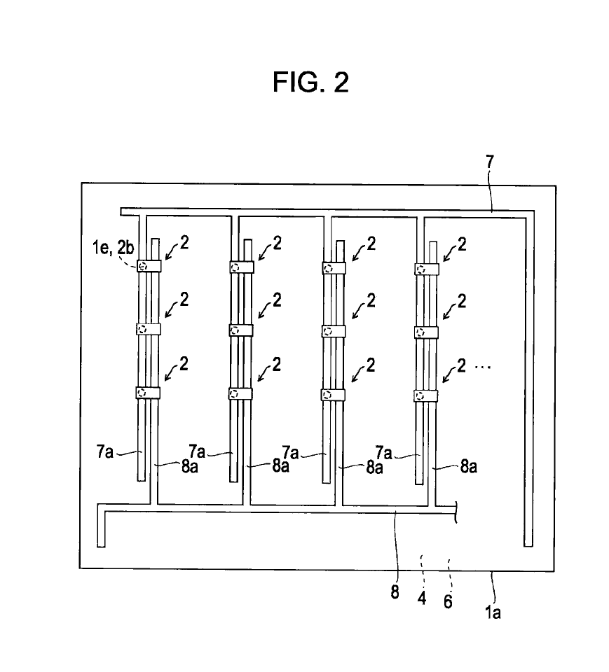

The illumination unit 10 includes a pair of glass substrates 1a and 1b, and multiple organic electroluminescence elements (hereinafter, “organic EL elements”) 2 disposed between the glass substrates 1a and 1b. The glass substrate 1a and the glass substrate 1b are affixed to each other by a sealant layer 3 composed of a resin or the like that has been applied to the periphery portions of those substrates. A resin layer 4 is formed upon the surface of the glass substrate 1a, and the organic EL elements 2 are formed upon the surface of the resin layer 4. The organic EL elements 2 are disposed in a matrix form when viewed from above (see FIG. 2). Meanwhile, light-blocking films 5 are formed on the surface of the glass substrate 1a on the side thereof on which the organic EL elements 2 are formed, in positions corresponding to the regions in which the organic EL elements 2 are disposed. Note that the glass substrate 1a and the resin layer 4 are examples of a “substrate” and a “first resin layer”, respectively, according to the invention.

Each organic EL element 2 is configured by layering an anode layer 2a, an organic layer 2b, and a cathode layer 2c in that order, and is configured so that the organic layer 2b emits light when a voltage is applied between the anode layer 2a and the cathode layer 2c. Meanwhile, a light-transmissive insulating layer 6 is formed upon the surface of the anode layer 2a in the regions in which the organic layer 2b is not provided. The insulating layer 6 is provided in order to suppress short-circuits between the anode layer 2a and the cathode layer 2c. In addition, as shown in FIG. 1 and FIG. 2, a first transparent electrode 7 and a second transparent electrode 8, configured of ITO and formed in a comb-tooth shape, are formed upon the surface of the resin layer 4. The comb-tooth first transparent electrode 7 and second transparent electrode 8 are configured so that their respective tooth portions 7a and 8a are disposed in an alternating manner. The configuration is such that a positive voltage is applied to the anode layer 2a from the first transparent electrode 7 via the tooth portions 7a and a negative voltage is applied to the cathode layers 2c from the second transparent electrode 8 via the tooth portions 8a. Furthermore, reflective layers 9 are formed between each organic EL element 2 and the resin layer 4. The reflective layers 9 are configured of, for example, aluminum, and function to reflect light leaking in the direction of an arrow Z1 from the organic layers 2b so as to irradiate that light toward the glass substrate 1b (in the direction of an arrow Z2). Note that the organic layers 2b are examples of a “light emitting layer” according to the invention.

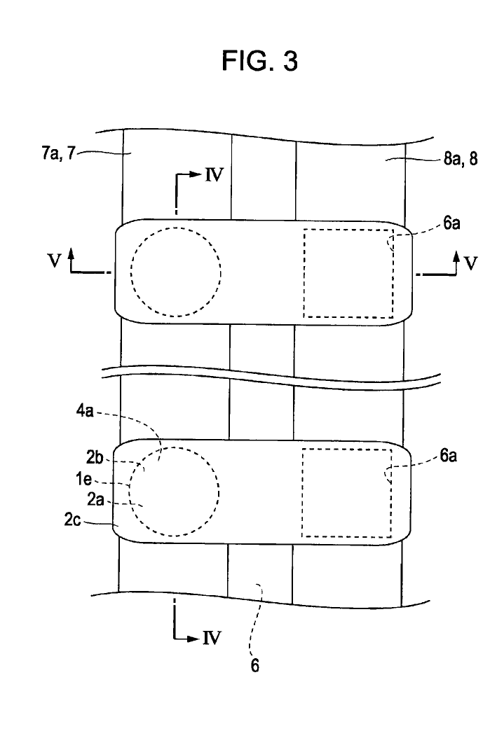

Here, the configuration of the regions in which the organic EL elements 2 are formed, which serve as a light source portions, will be described in detail with reference to FIGS. 3 through 5.

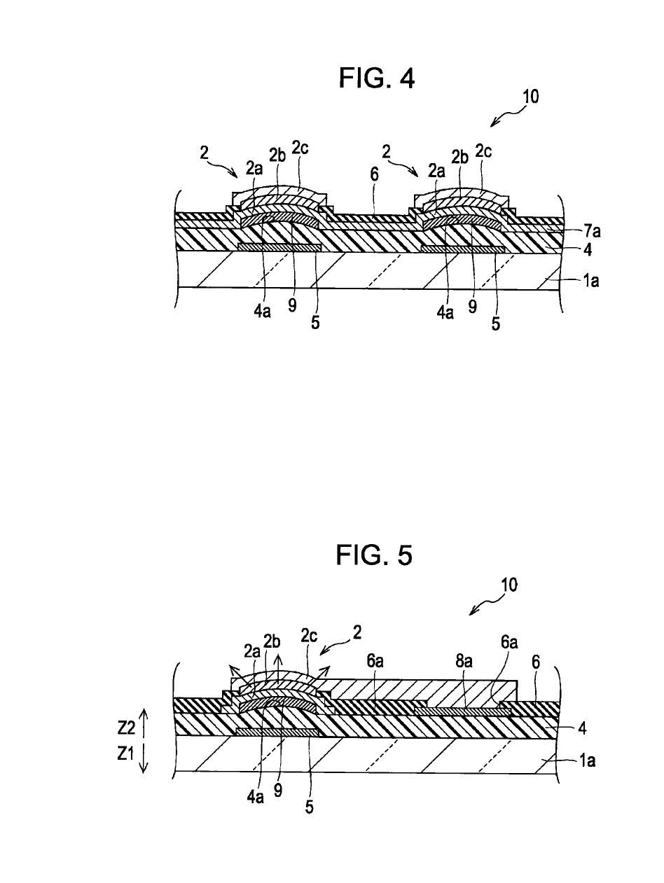

First, as shown in FIG. 3 and FIG. 4, the organic layers 2b are provided at predetermined intervals upon the surface of the tooth portion 7a of the first transparent electrode 7, and the regions of the tooth portion 7a on which the organic layers 2b are disposed are configured as the anode layers 2a. The cathode layers 2c are formed so as to cover the organic layers 2b.

Furthermore, as shown in FIG. 3 and FIG. 5, the insulating layer 6 is formed upon the surface of the tooth portion 8a, and hole portions 6a are formed in the regions of the insulating layer 6 that are positioned on top of the tooth portion 8a. The configuration is such that the cathode layers 2c make contact with the tooth portion 8a of the second transparent electrode 8 via the hole portions 6a. The cathode layers 2c are formed so as to cover the hole portions 6a and to extend from the hole portions 6a to a position that covers the organic layers 2b. The cathode layers 2c are configured of a transparent electrode such as ITO or the like.

According to this configuration, a positive voltage applied to the tooth portion 7a (anode layers 2a) of the first transparent electrode 7 and a negative voltage applied to the cathode layers 2c via the tooth portion 8a of the second transparent electrode 8 are applied to the organic layers 2b, and as a result, the organic layers 2b emit light in the direction of the arrow Z2. Furthermore, the configuration is such that light leaking from the organic layers 2b in the direction of the arrow Z1 is reflected by the reflective layers 9 and irradiated toward the glass substrate 1b (in the direction of the arrow Z2). In other words, the illumination unit 10 according to the first embodiment is configured as a top emission-type unit that irradiates light from the organic EL elements 2 toward the exterior (in the direction of the arrow Z2) via the glass substrate 1b.

Here, in the first embodiment, convex-shaped portions 4a are provided as part of the resin layer 4 in the surface of the resin layer 4 on the side in which the organic EL elements 2 are disposed (the side of the direction of the arrow Z2), in areas corresponding to the regions in which the organic layers 2b and the reflective layers 9 are disposed (in the first embodiment, directly below the organic layers 2b), the convex-shaped portions 4a being formed so as to protrude toward the organic layer 2b. The reflective layers 9 are disposed so as to cover the convex-shaped portions 4a of the resin layer 4, and are formed in a convex shape in accordance with the shape of the convex-shaped portions 4a. Meanwhile, the anode layers 2a, organic layers 2b, and cathode layers 2c formed upon the surface of the reflective layers 9 are also formed in a convex shape in accordance with the shapes of the convex-shaped portions 4a and the reflective layers 9. Accordingly, the reflective layers 9, anode layers 2a, organic layers 2b, and cathode layers 2c have shapes that protrude in the light-emission direction (the direction of the arrow Z2).

Furthermore, in the first embodiment, as shown in FIG. 3, the convex-shaped portions 4a have a circular shape when viewed from above, and the organic layers 2b disposed above the convex-shaped portions 4a are also formed to have the same circular shape as the convex-shaped portions 4a.

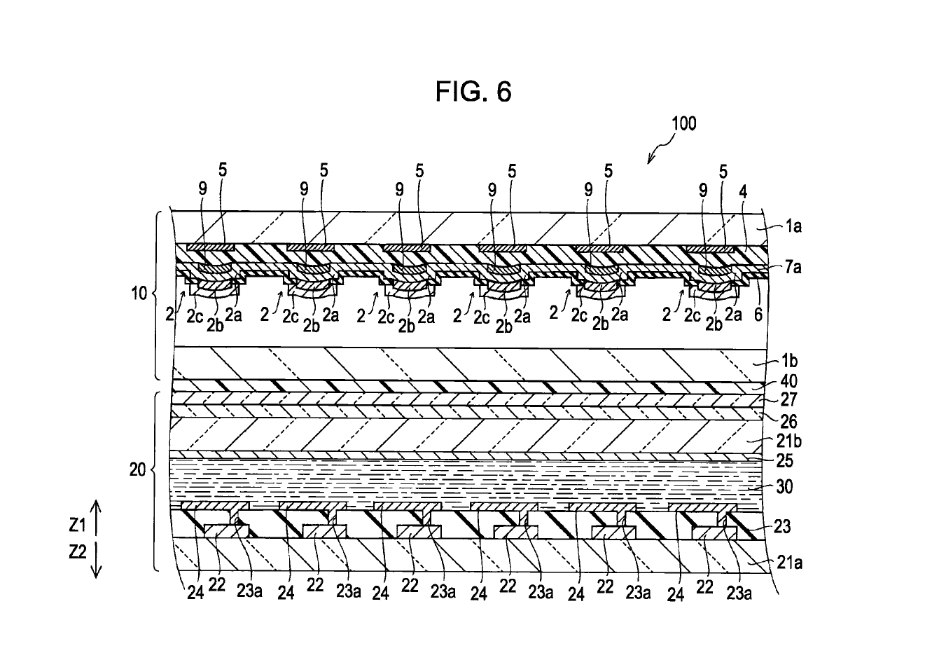

Next, the configuration of the reflective liquid crystal display unit 20 will be described with reference to FIG. 6. The reflective liquid crystal display unit 20 includes a pair of glass substrates 21a and 21b, and multiple thin-film transistors (TFTs) 22 used for switching are formed upon the surface of the glass substrate 21a. An interlayer insulating film 23 is formed upon the surface of the thin-film transistors 22, and pixel electrodes 24 are formed upon the surface of the interlayer insulating film 23 so as to correspond to respective thin-film transistors 22. Respective thin-film transistors 22 and pixel electrodes 24 are connected to each other via contact holes 23a formed in the interlayer insulating film 23. The pixel electrodes 24 are configured of a reflective material such as aluminum, and function to reflect light that has entered from the illumination unit 10 toward an observer (in the direction of the arrow Z1). Meanwhile, a common electrode 25 is formed on the surface of the glass substrate 21b on the side thereof that opposes the glass substrate 21a (that is, the side in the direction of the arrow Z2). A liquid crystal 30 is provided between the glass substrates 21a and 21b. A light diffusing layer 26 is formed upon the surface of the glass substrate 21b on the side thereof that is opposite to the surface on which the common electrode 25 is formed (that is, the side in the direction of the arrow Z1), and a polarizer 27 is formed upon the surface of the light diffusing layer 26.

The reflective liquid crystal display unit 20 and the illumination unit 10 are affixed to each other by a resinous adhesive layer 40 provided between the polarizer 27 of the reflective liquid crystal display unit 20 and the glass substrate 1a of the illumination unit 10.

According to the first embodiment, forming the reflective layers 9 in a convex shape protruding toward the organic layers 2b as described above makes it possible, when light from the organic layers 2b is reflected by the reflective layers 9, to irradiate the reflected light across a more widely dispersed range than in the case where the reflective layers 9 are formed in a flat shape. Accordingly, because the light from the organic layers 2b can be dispersed by the reflective layers 9 and irradiated, the occurrence of unevenness in the overall light emitted from the illumination unit 10 can be suppressed, even if the numerical aperture is increased by increasing the interval at which the organic layers 2b and reflective layers 9 are disposed. This makes it possible to irradiate the reflective liquid crystal display unit 20 disposed on the light-emission side of the illumination unit 10 (the side in the direction of the arrow Z2) with light that has no unevenness. Furthermore, even when the illumination unit 10 is irradiated with reflected light from the reflective liquid crystal display unit 20, the interval at which the organic layers 2b are disposed can be increased (the numerical aperture can be increased) without causing the occurrence of unevenness in the light, which makes it possible to suppress the reflected light from being blocked by the organic layers 2b. Accordingly, a drop in the luminance of the light irradiated toward the observer can be suppressed by that amount.

Furthermore, according to the aforementioned first embodiment, the organic layers 2b are formed so as to cover the surface of the reflective layers 9 and are formed in a convex shape in accordance with the convex shape of the reflective layers 9, and thus the organic layers 2b and reflective layers 9 are formed in corresponding convex shapes; therefore, in addition to the reflected light reflected by the reflective layers 9, the light emitted directly from the organic layers 2b in the light-emission direction can be dispersed and irradiated.

Furthermore, in the aforementioned first embodiment, the configuration is such that the convex-shaped portions 4a are formed in the surface of the resin layer 4 so as to protrude in the direction of the glass substrate 1b and the reflective layers 9 are provided in a convex shape in accordance with the shape of the convex-shaped portions 4a, and light leaking from the organic layers 2b in the direction of the arrow Z1 is reflected by the reflective layers 9 and emitted toward the glass substrate 1b as a result. Employing such a configuration makes it possible to configure a top-emission type illumination unit 10 that irradiates light from the organic layers 2b toward the glass substrate 1b, and makes it possible to easily form the reflective layers 9 in a convex shape in accordance with the shape of the convex-shaped portions 4a.

Furthermore, according to the aforementioned embodiment, the convex-shaped portions 4a are formed as part of the surface of the resin layer 4 on the side thereof on which the reflective layers 9 are disposed, thus making it possible to simplify the structure as compared to a case where the convex-shaped portions 4a are disposed independently. Moreover, forming the reflective layers 9 so as to cover the convex-shaped portions 4a of the resin layer 4 makes it possible to easily form the reflective layers 9 in a convex shape.

Finally, according to the aforementioned first embodiment, the convex-shaped portions 4a are formed in a circular shape when viewed from above, and thus when light is dispersed by the convex-shaped portions 4a, it is possible to disperse the light uniformly in all directions when viewed from above.

### Second Embodiment

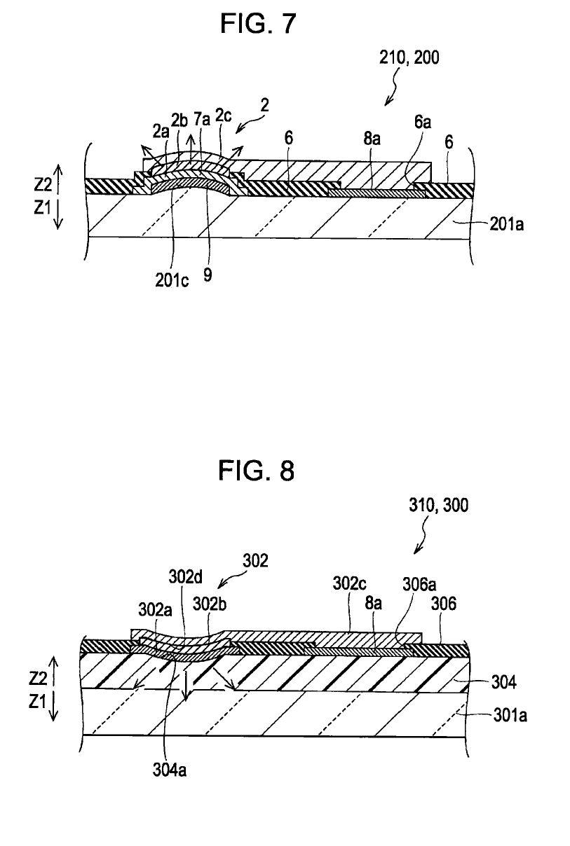

Next, a second embodiment will be described with reference to FIG. 7. Unlike the aforementioned first embodiment, in which the convex-shaped portions 4a are formed in the surface of the resin layer 4 disposed upon the surface of the glass substrate 1a in the illumination unit 10, the second embodiment describes an example in which convex-shaped portions 201c are formed in the surface of a glass substrate 201a.

An illumination unit 210 in a display apparatus 200 according to the second embodiment of the invention is, as shown in FIG. 7, formed of organic EL elements 2, each configured of a reflective layer 9, an anode layer 2a, an organic layer 2b, and a cathode layer 2c, formed upon a first surface 201c of the glass substrate 201a, and an insulating layer 6.

Here, in the second embodiment, the convex-shaped portions 201c are formed as part of the glass substrate 201a in the surface of the glass substrate 201a on the side in which the organic EL elements 2 are disposed, in areas corresponding to the regions in which the organic layers 2b are disposed (directly below the organic layers 2b). Reflective layers 9 and the organic layers 2b are formed so as to cover respective convex-shaped portions 201c, and are formed in a convex shape in accordance with the shape of the convex-shaped portions 201c.

Note that the other configurations in the second embodiment are the same as those described above in the first embodiment.

As described thus far, according to the second embodiment, light irradiated from the organic EL elements 2 can be emitted to the reflective liquid crystal display unit 20 while diffusing that light even in the case where the convex-shaped portions 201c are formed as part of the surface of the glass substrate 201a.

Furthermore, according to the second embodiment, the convex-shaped portions 201c are formed as part of the surface of the glass substrate 201a on the side thereof on which the reflective layers 9 are disposed, thus making it possible to simplify the structure as compared to a case where the convex-shaped portions 201c are disposed independently. Moreover, forming the reflective layers 9 so as to cover the convex-shaped portions 201c formed in the glass substrate 201a makes it possible to easily form the reflective layers 9 in a convex shape.

Note that the other effects of the second embodiment are the same as those described in the aforementioned first embodiment.

### Third Embodiment

Next, a third embodiment will be described with reference to FIG. 8. Unlike the aforementioned first (second) embodiment, in which the convex-shaped portions 4a (201c) are formed so as to protrude from the glass substrate 1a (201a) toward the organic EL elements 2, the third embodiment describes an example in which convex-shaped portions 302d are formed so as to protrude from the direction of organic EL elements 302 and toward a glass substrate 301a.

With an illumination unit 310 in a display apparatus 300 according to the third embodiment of the invention, as shown in FIG. 8, a resin layer 304 is formed upon the surface of the glass substrate 301a on the side in the direction of the arrow Z2, and the organic EL elements 302, each configured of an anode layer 302a, an organic layer 302b, and a cathode layer 302c, are formed upon the surface of the resin layer 304, along with an insulating layer 306. Note that the glass substrate 301a and the resin layer 304 are examples of a “light-transmissive substrate” and a “second resin layer”, respectively, according to the invention.

Here, in the third embodiment, concave-shaped portions 304a are formed as part of the resin layer 304 in the surface of the resin layer 304 on the side in the direction of the arrow Z2, in areas corresponding to the regions in which the organic layers 302b are disposed (directly below the organic layers 302b). The anode layers 302a and organic layers 302b are formed in a convex shape protruding in the direction of the arrow Z1, in accordance with the shape of the concave-shaped portions 304a in the resin layer 304. Furthermore, the convex-shaped portions 302d are formed in regions of the cathode layers 302c that cover the organic layers 302b, and are provided in accordance with the shape of the organic layers 302b, protruding in the direction of the arrow Z1. The cathode layers 302c are configured of, for example, aluminum, and are configured so as to function as reflective layers. In other words, the illumination unit 310 according to the third embodiment is configured as a bottom illumination-type illumination apparatus, whereby when the organic layers 302b emit light, the light moving in the direction of the arrow Z2 is reflected in the direction of the arrow Z1 by the cathode layers 302c functioning as reflective layers and is then irradiated toward the reflective liquid crystal display unit 20 via the glass substrate 301a. Furthermore, the configuration is such that due to the convex shape of the organic layers 302b and the cathode layers 302c protruding in the direction of the arrow Z1, the light irradiated from the organic layers 302b in the direction of the arrow Z1 and the reflected light reflected by the cathode layers 302c in the direction of the arrow Z1 are both irradiated toward the glass substrate 301a while being diffused.

Note that the other configurations in the third embodiment are the same as those described above in the first and second embodiments.

As described thus far, according to the third embodiment, the concave-shaped portions 304a are formed in the resin layer 304, and the organic layers 302b and cathode layers 302c are formed in accordance with the shape of the concave-shaped portions 304a and protruding in the direction of the arrow Z1; accordingly, even in the case where the bottom illumination-type is employed as the configuration of the illumination unit 310, the light emitted from the organic layers 302b in the direction of the arrow Z2 can be reflected by the convex-shaped portions 302d of the cathode layers 302c, and the light can be irradiated in the direction of the arrow Z1 while being diffused.

Furthermore, according to the third embodiment, forming the cathode layers 302c (the reflective layers) so as to cover the resin layer 304 in which the concave-shaped portions 304a are formed as a part thereof makes it possible to easily form the cathode layers 302c having the convex-shaped portions 302d in correspondence with the concave-shaped portions 304a, protruding in the direction of the arrow Z1.

Note that the other effects of the third embodiment are the same as those described in the aforementioned first and second embodiments.

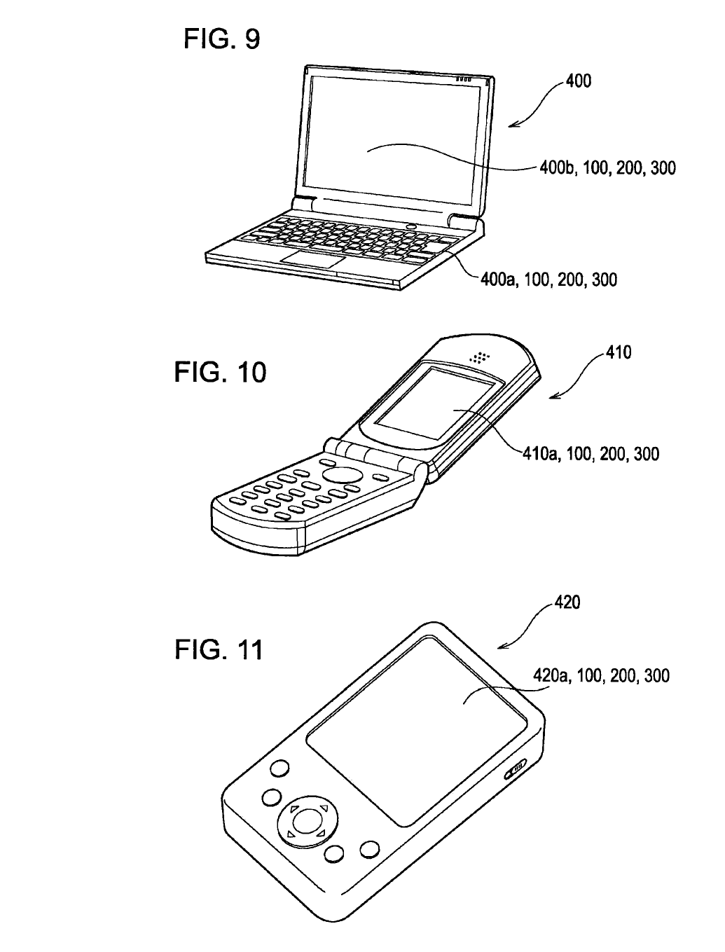

Next, first through third examples of electronic devices that use the display apparatuses 100, 200, and 300 according to the first through third embodiments of the invention will be described with reference to FIGS. 9 through 11.

The display apparatuses 100, 200, and 300 according to the first through third embodiments of the invention can be employed in, for example, a PC (personal computer) 400, which is the first example, a mobile telephone 410, which is the second example, a personal digital assistant (PDA) 420, which is the third example, and so on, as shown in FIGS. 9 through 11. With the PC 400 according to the first example shown in FIG. 9, the display apparatuses 100, 200, and 300 according to the first through third embodiments of the invention can be employed in an input unit 400a such as a keyboard, a display screen 400b, or the like. With the mobile telephone 410 according to the second example shown in FIG. 10, the display apparatuses 100, 200, and 300 according to the first through third embodiments of the invention can be employed in a display screen 410a. Finally, with the personal digital assistant 420 according to the third example shown in FIG. 11, the display apparatuses 100, 200, and 300 according to the first through third embodiments of the invention can be employed in a display screen 420a.

Note that the descriptions disclosed in the above embodiments are to be understood as being in all ways exemplary and in no way limiting. The scope of the invention is defined by the appended claims rather than the descriptions of the aforementioned embodiments, and many modifications may be made within the same scope as the appended claims.

For example, although the aforementioned first through third embodiments describe an example in which the first transparent electrode and second transparent electrode that supply a voltage to the anode layers and cathode layers are formed in a comb-tooth shape, the invention is not limited thereto, and the configuration may be such that another shape aside from a comb-tooth shape is employed for the anode layers (first transparent electrode) and cathode layers (second transparent electrode).

Furthermore, although the aforementioned first through third embodiments describe an example in which the organic EL elements are disposed in a matrix form, the invention is not limited thereto, and the organic EL elements may be disposed in a form aside from a matrix.

Furthermore, although the aforementioned first through third embodiments describe an example in which an insulating layer is formed so as to cover approximately the entirety of the first transparent electrode and the second transparent electrode, the invention is not limited thereto, and the organic layer may be provided only in regions surrounding the organic layers so as not to make contact with the cathode layers and anode layers.

Furthermore, although the aforementioned first and second embodiments describe an example in which the reflective layers and the anode layers, organic layers, and cathode layers in the organic EL elements are respectively configured so as to have a convex shape in accordance with the convex-shaped portions, the invention is not limited thereto, and any configuration may be employed as long as at least the reflective layers have a convex shape.

Finally, although the aforementioned third embodiment describes an example in which the concave-shaped portions are formed in the surface of the resin layer provided between the glass substrate and the organic EL elements, the invention is not limited thereto, and the concave-shaped portions may be formed in the surface of the glass substrate on the side of the organic EL elements.

This application claims priority to Japanese Patent Application No. 2009-059059 filed Mar. 12, 2009 which is hereby expressly incorporated by reference herein in its entirety.

1. An illumination apparatus comprising:
a substrate;
reflective layers formed upon the substrate; and
light-emitting layers formed upon respective reflective layers and disposed so as to overlap the respective reflective layers when viewed from above,
wherein the reflective layers are formed in a convex shape protruding toward the respective light-emitting layers, and when reflecting light irradiated from the light-emitting layers, diffuse and reflect the light.

2. The illumination apparatus according to claim 1, wherein the light-emitting layers are formed in a convex shape protruding in the same direction as the direction in which the reflective layers protrude.

3. The illumination apparatus according to claim 1, further comprising:
convex-shaped portions formed between the substrate and the reflective layers and projecting in the direction from the substrate toward the reflective layers,
wherein the reflective layers are provided between the respective light-emitting layers and the convex-shaped portions in a convex shape in accordance with the shape of the convex-shaped portions, and are configured so that of the light irradiated from the light-emitting layers, the light moving toward the substrate is reflected by the reflective layers in the direction opposite to the substrate and is emitted.

4. The illumination apparatus according to claim 3, further comprising:
a first resin layer provided between the substrate and the reflective layers,
wherein the convex-shaped portions are formed in the surface of the first resin layer on the side thereof on which the reflective layers are disposed, and are formed as part of the first resin layer; and
the reflective layers are formed so as to cover the convex-shaped portions of the first resin layer.

5. The illumination apparatus according to claim 3,
wherein the convex-shaped portions are formed in the surface of the substrate on the side thereof on which the reflective layers are disposed, and are formed as part of the substrate; and
the reflective layers are formed so as to cover the convex-shaped portions of the substrate.

6. The illumination apparatus according to claim 3, wherein the convex-shaped portions are formed in a circular shape when viewed from above.

7. An illumination apparatus comprising:
a light-transmissive substrate;
concave-shaped portions formed upon the light-transmissive substrate;
light-emitting layers formed upon respective concave-shaped portions and disposed so as to overlap the respective concave-shaped portions when viewed from above; and
reflective layers formed upon respective light-emitting layers,
wherein the reflective layers are formed in a convex shape protruding toward the light-transmissive substrate in accordance with the shape of the concave-shaped portions, and when reflecting light irradiated from the light-emitting layers, diffuse and reflect the light.

8. The illumination apparatus according to claim 7, further comprising:
a second resin layer provided between the light-transmissive substrate and the light-emitting layers,
wherein the concave-shaped portions are formed in the second resin layer.

9. The illumination apparatus according to claim 1,
wherein the light-emitting layers are configured of organic layers, and
the apparatus further comprises:
anode layers and cathode layers that apply a voltage for causing respective organic layers to emit light,
wherein organic electroluminescence elements are configured from respective organic layers, anode layers, and cathode layers; and
the organic layers of each organic electroluminescence element are formed in a convex shape protruding in the direction in which the convex shape of the reflective layers protrudes.

10. A display apparatus comprising:
the illumination apparatus according to claim 1; and
a display unit that performs a display by reflecting light from the illumination apparatus.

11. The display apparatus according to claim 10,
wherein the display unit is configured of a reflective liquid crystal display unit;
the light-emitting layers of the illumination apparatus are configured of organic layers;
the illumination apparatus further includes anode layers and cathode layers that apply a voltage for causing respective organic layers to emit light;
organic electroluminescence elements are configured from respective organic layers, anode layers, and cathode layers; and
the apparatus is configured so that light from the light-emitting layers of the illumination apparatus is irradiated onto the reflective liquid crystal display unit in a state in which the light is diffused by the convex-shaped reflective layers.

12. An electronic device comprising the display apparatus according to claim 10.
